(19) United States
(12) Patent Application Publication
(10) Pub. No.: US 2009/0034038 A1
(43) Pub. Date: Feb. 5, 2009

(54) OSCILLATING DEVICE, LIGHT DEFLECTOR, AND IMAGE FORMING APPARATUS USING THE LIGHT DEFLECTOR

(75) Inventors: Kazutoshi Torashima, Irvine, CA (US); Takahisa Kato, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/174,880

(22) Filed: Jul. 17, 2008

(30) Foreign Application Priority Data
Jul. 30, 2007 (JP) 2007-197393

(51) Int. Cl. G02B 26/08

(52) U.S. Cl. 359/198

(57) ABSTRACT

An oscillating device is disclosed that maintains the flatness of a movable portion during driving. The oscillating device has a supporting portion, a movable portion, a torsion spring connecting the movable portion to the supporting portion in a manner allowing the movable portion to torsionally oscillate about a torsional axis, and a driving unit configured to oscillate the movable portion. The movable portion is made of single-crystal silicon. The principal surface of the movable portion lies in the (110) crystal plane, and the crystal orientation of the movable portion parallel to the principal surface and perpendicular to the torsional axis is the [111] orientation.

### BACKGROUND OF THE INVENTION

1. Field of the Invention

The present invention relates to oscillating devices, light deflectors, and optical apparatuses using the light deflectors, such as image forming apparatuses and displays. Light deflectors are suitably used in, for example, projection displays that project images by deflecting light and performing scanning, image forming apparatuses using electrophotography processes, such as laser beam printers and digital copying machines.

2. Description of the Related Art

Various optical scanning systems and optical scanning apparatuses serving as light deflectors that deflect light by sinusoidally oscillating movable portions having reflecting surfaces are known. Compared to optical scanning systems using rotatable polygonal mirrors, optical scanning systems using light deflectors that sinusoidally oscillate utilizing resonance have significantly smaller light deflectors and consume less power. In particular, light deflectors made of single-crystal silicon, by a semiconductor process, theoretically produce no metal fatigue and have better durability.

U.S. Pat. No. 4,317,611 discloses a light deflector made of silicon, which is shown in FIG. 8 as an exemplary light deflector. FIG. 8 is a perspective view of the light deflector.

The light deflector shown in FIG. 8 has a supporting portion 20, a movable portion 30, and torsion springs 22, 24 connecting the movable portion 30 to the supporting portion 20 in a manner allowing the movable portion 30 to torsionally oscillate. The light deflector is made of a silicon wafer, using a photolithography process and an etching process used in a semiconductor manufacturing method.

The movable portion of the oscillating device torsionally oscillates by a predetermined angle and is subjected to great angular acceleration. Thus, the movable portion is subjected to an inertial force due to its own weight during driving and may be deformed. In particular, when laser scanning is performed using a light deflector whose movable portion has a reflecting surface, the deformation of the movable portion affects the optical characteristics of scanning light.

### SUMMARY OF THE INVENTION

The present invention provides an oscillating device in which the amount of deformation of a movable portion during torsional oscillation is reduced.

An oscillating device according to the present invention has a supporting portion, a movable portion, a torsion spring connecting the movable portion to the supporting portion in a manner allowing the movable portion to torsionally oscillate about a torsional axis, and a driving unit configured to oscillate the movable portion. The movable portion is made of single-crystal silicon. A principal surface of the movable portion lies in a (110) crystal plane. A crystal orientation parallel to the principal surface of the movable portion and perpendicular to the torsional axis is a [111] orientation.

This configuration further reduces the amount of deformation of the movable portion, compared to a configuration in which the principal surface of the movable portion lies in another crystal plane or the crystal orientation is another orientation. Accordingly, it is possible to provide an oscillating device that maintains the flatness of the movable portion during torsional oscillation.

Further features of the present invention will become apparent from the following description of exemplary embodiments with reference to the attached drawings.

### BRIEF DESCRIPTION OF THE DRAWINGS

FIGS. 1A and 1B are respectively a plan view and a sectional view of an oscillating device according to an embodiment of the present invention, and also respectively a plan view and a sectional view of a light deflector according to Example 1.

FIGS. 2A and 2B are respectively a plan view and a sectional view of a light deflector according to Example 2 of the present invention.

FIG. 3 is a plan view of a light deflector according to Example 3 of the present invention.

FIG. 4 is a schematic diagram of an image forming apparatus according to Example 4 of the present invention.

FIGS. 5A, 5B, and 5C show deformation of the light deflector.

FIG. 6 is a graph showing the relationships between the amounts of deformation of movable portions of the present invention and the crystal planes of substrates of which the movable portions are made.

FIG. 7 is a graph showing the relationships between the torsion spring constants of torsion springs of the present invention and the crystal planes of substrates of which the torsion springs are made.

FIG. 8 is a perspective view of a known light deflector.

### DESCRIPTION OF THE EMBODIMENTS

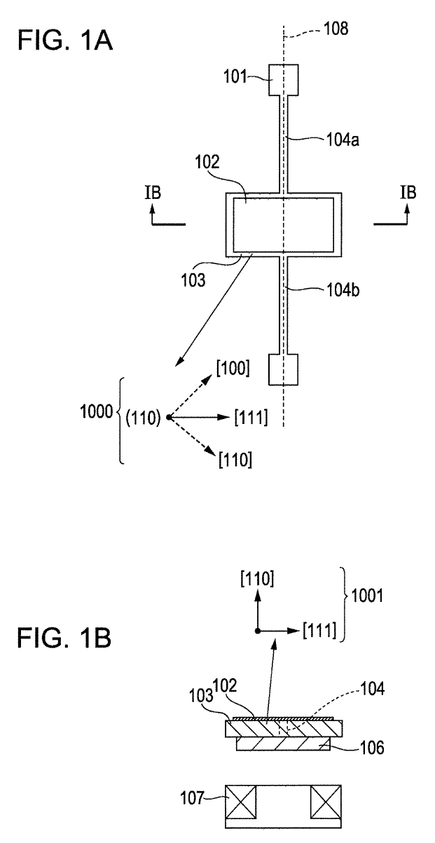

An embodiment of the present invention will now be described with reference to FIGS. 1A and 1B. FIG. 1A is a plan view of an oscillating device of the present invention, and FIG. 1B is a sectional view of the oscillating device shown in FIG. 1A, taken along line IB-IB. The oscillating device according to the present embodiment has supporting portions 101, a movable portion 103, and torsion springs 104a, 104b connecting the movable portion 103 to the supporting portions 101 in a manner allowing the movable portion 103 to torsionally oscillate about a torsional axis 108. The supporting portions 101 are fixed to a fixed member such as a supporting substrate so that the supporting portions 101 do not move when the movable portion 103 torsionally oscillates. The oscillating device according to the present embodiment may be used as a light deflector by providing a reflecting surface 102 on the surface of the movable portion 103. The reflecting surface 102 may be made of a thin film of, for example, gold or copper, and a protective film may be formed thereon. Alternatively, the reflecting surface 102 may be made of a dielectric multilayer film.

The movable portion 103 is made of a single-crystal silicon substrate, and the principal surface (the surface having the reflecting surface 102 in FIGS. 1A and 1B) of the movable portion 103 lies in the (110) crystal plane or the crystal planes equivalent thereto (i.e., the {110} planes). The crystal orientation parallel to the principal surface of the movable portion 103 and perpendicular to the torsional axis 108 is the [111] orientation or the orientations equivalent thereto.

Herein, the planes equivalent to the (111) crystal plane, such as the (−1−1−1) crystal plane and the (−111) crystal plane, are referred to as “(111) equivalent planes” (i.e., the {111} planes). Likewise, the orientations equivalent to the [111] orientation, such as the [−1−1−1] orientation and the [−111] orientation, are referred to as “[111] equivalent orientations”.

The oscillating device according to the present embodiment is made of, for example, a single-crystal silicon substrate whose principal surface lies in the (110) crystal plane, and has the supporting portions 101, the movable portion 103, and the torsion springs 104a, 104b that are integrally formed.

In FIGS. 1A and 1B, a crystal orientation 1000 of the movable portion 103 parallel to the principal surface of the movable portion 103 and perpendicular to the torsional axis 108 is the [111] orientation. Herein, the [111] orientation refers to the [111] orientation give or take 5 degrees, including substantially the [100] orientation. Where the crystal orientation 1000 is within this range, the amounts of deformation of the movable portions due to their own weight are substantially uniform.

The oscillating device according to the present embodiment further has a driving unit configured to drive the movable portion 103. Examples of the driving unit include a coil and a magnet when the driving unit is of an electromagnetic type, an electrode when the driving unit is of an electrostatic type, and a piezoelectric element when the driving unit is of a piezoelectric type. Referring to FIG. 1B, for example, the movable portion 103 has a hard magnet 106, and is magnetized perpendicular to the torsional axis 108 (the left-right direction in FIG. 1B). The hard magnet 106 may be formed on the movable portion 103 by a sputtering process, or the hard magnet 106 may be attached to the movable portion 103. When a driving current is applied from a driving control unit (not shown) to a coil 107 serving as a driving unit, a magnetic field is generated. Then, a torque is applied to the movable portion 103, thereby driving the oscillating device. If an AC current is applied to the coil 107, the oscillating device torsionally oscillates at the frequency of the AC current. In addition, if an AC current having a frequency equal to the resonance frequency of the oscillating device of the present invention is applied to the coil 107, the oscillating device torsionally and resonantly oscillates while consuming less power.

Principles of the present invention are described below.

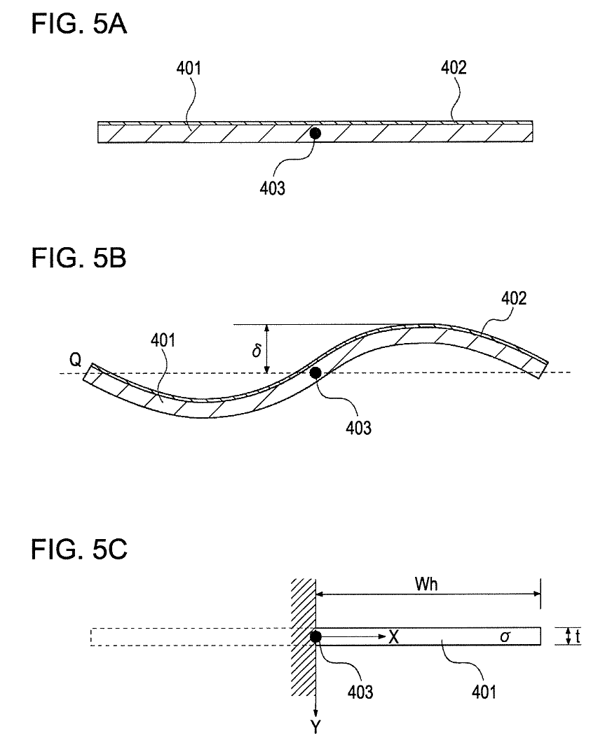

FIG. 5A is a sectional view of a movable portion 401 in the shape of a flat plate (rectangular parallelepiped), taken along a line perpendicular to the torsional axis. Assuming that the oscillating device is driven to torsionally oscillate at a frequency around the resonance frequency, the displacement angle of the movable portion 401 changes sinusoidally with time. The most significant deformation occurs at a portion subjected to the greatest angular acceleration.

FIG. 5B is a sectional view of the movable portion 401 being deformed. As shown in FIG. 5B, when the movable portion 401 is deformed, the reflecting surface 402 provided on the movable portion 401 is also deformed. When the oscillating device is used as a light deflector, a significant deformation of the movable portion 401 degrades the flatness of the reflecting surface 402, leading to a significant degradation in the optical characteristics of the light deflector.

The approximation model shown in FIG. 5B shows the deformation of the movable portion 401 during torsional oscillation, when the movable portion 401 is in the shape of a rectangular parallelepiped. The deformation of the movable portion 401 is point symmetrical with respect to the torsional axis 403, and may be approximated by the deformation of a beam as shown in FIG. 5C, which is fixed at one end corresponding to the torsional axis 403. When the movable portion 401 torsionally oscillates and is subjected to an angular acceleration of Θ(2πf)² (where Θ is the displacement angle, f is the frequency of torsional oscillation), the deformation (deflection) y of the beam shown in FIG. 5C is expressed in Expression 1.

$$y = 12 \cdot Θ \cdot {( 2 π f )}^{2} \cdot \frac{ρ {W}_{h}^{5}}{{Et}^{2}} ( \frac{{x}^{5}}{120} - \frac{{x}^{3}}{12} + \frac{{x}^{2}}{6} ) \qquad [ Expression 1 ]$$

where x is the dimensionless distance shown in FIG. 5C, ρ is the density of the component, E is the Young's modulus of the component, t is the thickness, and Wh is half the width W of the mirror.

The distance δ between the deformation (deflection) y and the reference plane Q affects the optical characteristics of the reflecting surface 402. Where the reference plane Q is as shown in FIG. 5B, the distance δ is expressed in Expression 2.

$$δ \approx 0.23 \cdot Θ \cdot {f}^{2} \cdot \frac{ρ {W}^{5}}{{Et}^{2}} \qquad [ Expression 2 ]$$

The distance δ is proportional to the displacement angle Θ, the width W of the mirror to the fifth power, and the frequency f squared. Thus, in the case of a larger reflecting surface area, a larger deflection angle, or a higher-frequency driving signal, the deformation of the movable portion due to its own weight becomes significant.

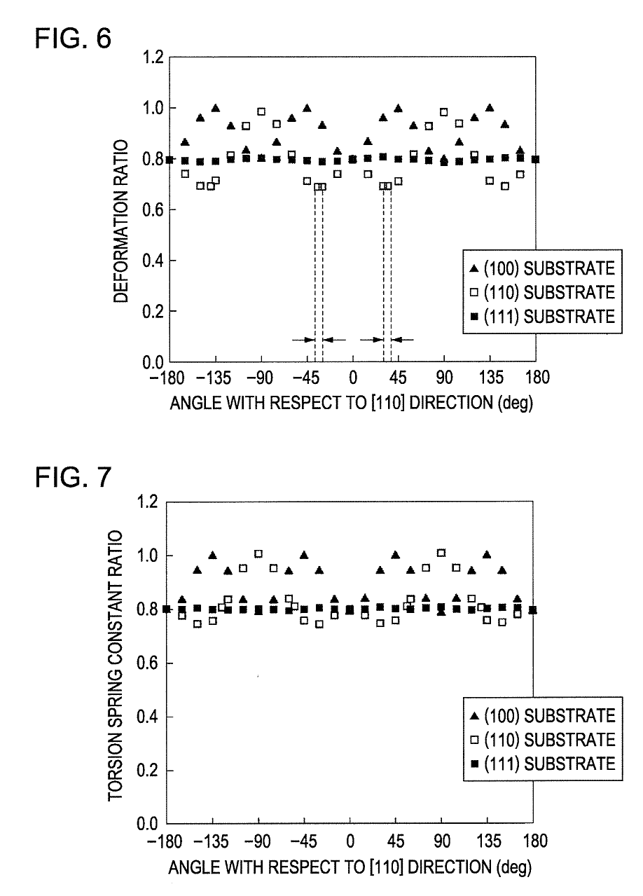

FIG. 6 is a graph showing the relationships between the amounts of deformation of movable portions of the present invention and the crystal planes of substrates of which the movable portions are made, calculated using a finite element method. This calculation took into account the crystal anisotropy of silicon.

The following physical properties were used in the calculation using a finite element method: the density of silicon=2300 kg/m³, and the stiffness coefficient (unit: Pa) shown below, which was used instead of Young's modulus (unit: Pa) in order to take into account the anisotropy of single-crystal silicon.

$$Stiffness Coefficient = ( \begin{matrix}C 11 & C 12 & C 12 & 0 & 0 & 0 \\ C 12 & C 11 & C 12 & 0 & 0 & 0 \\ C 12 & C 12 & C 11 & 0 & 0 & 0 \\ 0 & 0 & 0 & C 44 & 0 & 0 \\ 0 & 0 & 0 & 0 & C 44 & 0 \\ 0 & 0 & 0 & 0 & 0 & C 44\end{matrix} ) \qquad [ Expression 3 ]$$

where C11=167.4 GPa, C12=65.23 GPa, and C44=79.57 GPa.

It becomes possible to perform an analysis taking into account the crystal anisotropy, by creating finite element models of the components, such as a movable portion and torsion springs, using the above-noted physical properties, and by performing calculation using a finite element method.

In FIG. 6, the ordinate is the deformation ratio of movable portions, and the abscissa is the angle with respect to the [110] orientation. The deformation ratio of movable portions represents the amount of deformation of movable portions expressed as a decimal, where 1 is the amount of deformation of a movable portion whose principal surface lies in the (100) crystal plane and the crystal orientation parallel to the principal surface and perpendicular to the torsional axis is the [100] orientation (at this time, the angle with respect to the [110] orientation is 45 degrees, for example).

The angle with respect to the [110] orientation represents the angle of the crystal orientation parallel to the principal surface of the movable portion and perpendicular to the torsional axis with respect to the [110] orientation existing in the principal surface of the movable portion. Thus, when the crystal orientation parallel to the principal surface of the movable portion and perpendicular to the torsional axis is the [110] orientation, the angle with respect to the [110] orientation is 0 degrees.

Herein, a (100) substrate refers to a substrate whose principal surface lies in the (100) crystal plane. Likewise, a (110) substrate and a (111) substrate refer to substrates whose principal surfaces lie in the (110) crystal plane and the (111) crystal plane, respectively. For example, in the case of a (100) substrate, the crystal orientation that makes angles of ±45 degrees and ±135 degrees with respect to the [110] orientation is the [100] orientation. The crystal orientation that makes angles of 0 degrees, ±90 degrees, and ±180 degrees with respect to the [110] orientation is the [110] orientation. In the case of a (110) substrate, the crystal orientation that makes angles of 0 degrees and ±180 degrees with respect to the [110] orientation is the [110] orientation. The crystal orientation that makes angles of ±90 degrees with respect to the [110] orientation is the [100] orientation, and the crystal orientation that makes angles of ±35.3 degrees and ±144.7 degrees is the [111] orientation. In the case of a (111) substrate, the crystal orientation that makes angles of 0 degrees and ±180 degrees is the [110] orientation.

As shown in FIG. 6, where the crystal orientation parallel to the principal surface of the movable portion and perpendicular to the torsional axis makes an angle in the range from 0 degrees to 60 degrees with respect to the [110] orientation, the deformation ratio of movable portions made of a (110) substrate is smaller than those of movable portions made of (100) and (111) substrates. Further, where the crystal orientation parallel to the principal surface of the movable portion and perpendicular to the torsional axis makes an angle of 35.3 degrees with respect to the [110] orientation, the deformation ratio of movable portions made of a (110) substrate becomes smallest. At this time, the crystal orientation parallel to the principal surface of the movable portion and perpendicular to the torsional axis is the [111] orientation. Where the crystal orientation parallel to the principal surface of the movable portion and perpendicular to the torsional axis is the [111] orientation give or take 5 degrees, the amounts of deformation of the movable portions due to their own weight are substantially uniform.

As has been described, in the oscillating device according to the present embodiment, it is possible to reduce the amount of deformation of the movable portion having the reflecting surface during high-speed driving, utilizing the crystal anisotropy of silicon substrates. Accordingly, a light deflector using the oscillating device according to the present embodiment prevents deterioration in spot shape of deflected light (reflected light) during high-speed driving.

Torsion springs of the oscillating device according to the present embodiment are described below.

The torsion springs of the oscillating device according to the present embodiment are made of single-crystal silicon, whose crystal orientation parallel to the torsional axis is the [111] orientation. The [111] orientation includes the orientations equivalent thereto.

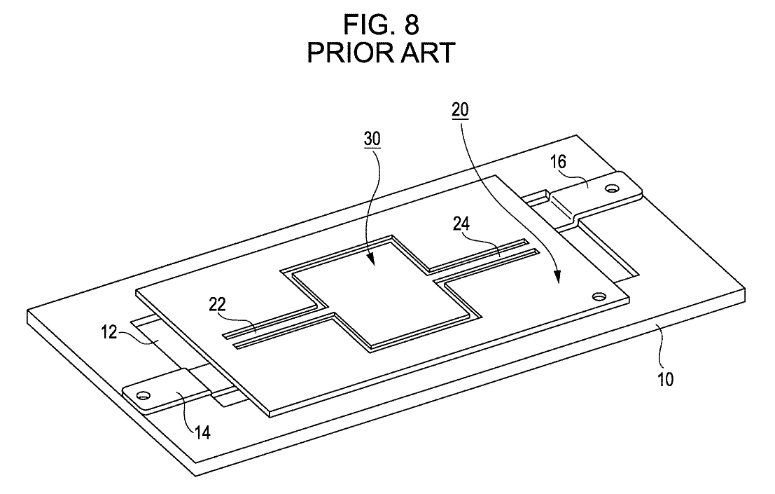

The effect of the use of the torsion springs will be described. FIG. 7 is a graph showing the relationships between the torsion spring constants of torsion springs of the present invention and the crystal planes of substrates of which the torsion springs are made, calculated using a finite element method. This calculation took into account the crystal anisotropy of silicon. The calculation using a finite element method shown in FIG. 7 used the same physical properties as the calculation shown in FIG. 6.

In FIG. 7, the ordinate is the torsion spring constant ratio, and the abscissa is the angle with respect to the [110] orientation. The torsion spring constant ratio represents the torsion spring constant expressed as a decimal, where 1 is the torsion spring constant of a torsion spring whose principal surface lies in the (100) crystal plane and the crystal orientation parallel to the torsional axis is the [100] orientation (in the (100) substrate in FIG. 7, the angle with respect to the [110] orientation is 45 degrees).

The angle with respect to the [110] orientation represents the angle of the crystal orientation of the torsion springs parallel to the torsional axis with respect to the [110] orientation. Thus, when the angle of the crystal orientation of the torsion springs parallel to the torsional axis with respect to the [110] orientation is 0 degrees, the crystal orientation of the torsion springs parallel to the torsional axis is the [110] orientation. The cross section of the torsion springs, i.e., a section perpendicular to the torsional axis, is rectangular.

As shown in FIG. 7, where the crystal orientation of the torsion springs parallel to the torsional axis makes an angle in the range from 0 degrees to 60 degrees with respect to the [110] orientation, the torsion spring constant of torsion springs made of a (110) substrate is smaller than those of torsion springs made of (100) and (111) substrates. Further, where the crystal orientation of the torsion springs parallel to the torsional axis is the [111] orientation (the angle with respect to the [110] orientation is 35.3 degrees), the torsion spring constant ratio of torsion springs made of a (110) substrate becomes smallest. The [111] orientation refers to the [111] orientation give or take 10 degrees, including substantially the [111] orientation. Where the crystal orientation of the torsion springs parallel to the torsional axis is within this range, the torsion spring constant ratios of the torsion springs are uniform. This crystal orientation may be the orientations equivalent thereto.

A comparison between a torsion spring made of a substrate whose principal surface lies in a crystal plane having a small torsion spring constant ratio and a torsion spring made of a substrate whose principal surface lies in a crystal plane having a large torsion spring constant ratio is as follows. When torsion springs having the same torsion spring constant are to be made, a substrate whose crystal plane and orientation have a small torsion spring constant ratio makes a larger torsion spring than a substrate whose crystal plane has a large torsion spring constant ratio. For example, when torsion springs having the same length are to be made, the torsion spring having a smaller torsion spring constant ratio can have a larger width. When torsion springs are to be made of single-crystal silicon substrates having the same degree of manufacturing error, the influence of the manufacturing error on the torsion spring constant is smaller for the torsion spring having a larger width. Thus, a torsion spring made of a substrate whose crystal plane and orientation have a small torsion spring constant ratio is less affected by manufacturing error of the single-crystal silicon substrate.

This configuration reduces variations in torsion spring constants due to manufacturing error of the width of torsion springs or the like. Accordingly, the amount of deformation of the movable portion during high-speed driving and variation in resonance frequency due to manufacturing error can be reduced.

The torsion spring may be made of a (111) substrate. As shown in FIG. 7, the spring constants of torsion springs made of a (111) substrate are substantially uniform over the entire range of angles with respect to the [110] orientation. Accordingly, even if the crystal orientation of torsion springs parallel to the torsional axis is misaligned with the intended orientation during fabrication, the torsion spring constants of the torsion springs are substantially uniform. Thus, variations in resonance frequency due to manufacturing error can be reduced.

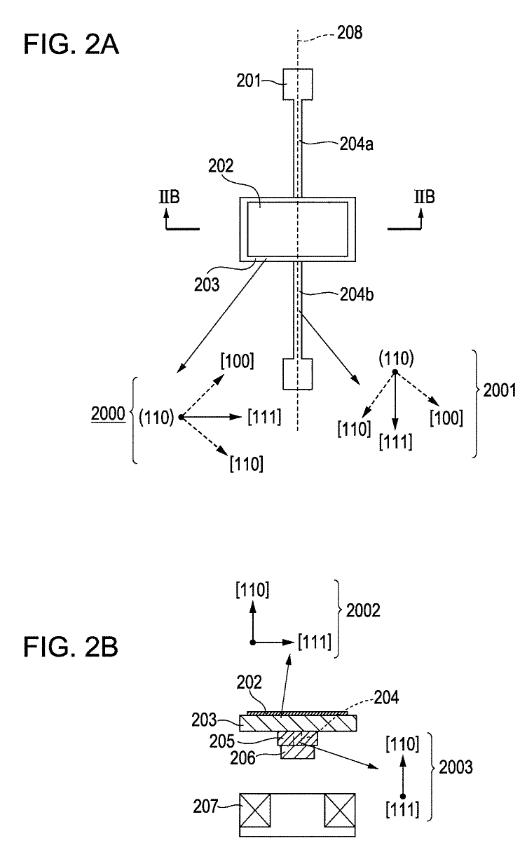

As shown in FIGS. 2A and 2B, in the oscillating device according to the present embodiment, it is possible to make the movable portion 203 separate from the supporting portions 201 and the torsion springs 204a, 204b. In that case, after the components are made, the movable portion 203 is adhered or bonded to a fixing portion 205.

The light deflector according to the present embodiment may have a plurality of movable portions, and a plurality of torsion springs configured to support the plurality of movable portions in a manner allowing the movable portion to torsionally oscillate about a single torsional axis. At least one of the plurality of movable portions has the reflecting surface. The plurality of movable portions oscillate about the torsional axis at a natural frequency serving as a reference frequency, and at a natural frequency that is an integral multiple of the reference frequency. The light deflector can perform an optical scanning in addition to a sinusoidal optical scanning, by oscillating the movable portions about the torsional axis at two or more natural frequencies simultaneously.

The image forming apparatus according to the present embodiment may have a light source, the light deflector, and a photosensitive body. The light deflector may deflect light emitted from the light source and irradiate the photosensitive body with a part of the light to form an electrostatic latent image. When a light deflector having a movable portion that is less deformed during high-speed driving is used, the spot shape of the reflected light is not deteriorated. Accordingly, deterioration in quality of images can be prevented.

A method for manufacturing the oscillating device according to the present embodiment will now be described.

When supporting portions, a movable portion, and torsion springs are integrally made of single-crystal silicon, for example, the following process is to be followed: First, the supporting portions, the movable portion, and the torsion springs are patterned on a (110) substrate, using a photolithography process. At this time, the crystal orientation parallel to the principal surface of the movable portion and perpendicular to the torsional axis is the [111] orientation. Then, non-patterned portions are removed using a wet or dry etching process. By integrally making the supporting portions, the movable portion, and the torsion springs using a semiconductor process, which has high processing accuracy, the oscillating devices can be fabricated highly accurately.

A method for fabricating a movable portion separately from supporting portions and torsion springs is described below.

The movable portion is made of a (110) substrate, using a wet or dry etching process or a dicing blade (a circular rotating blade). The movable portion is then joined to the torsion springs such that the crystal orientation parallel to the principal surface of the movable portion and perpendicular to the torsional axis is the [111] orientation. They may be joined together by adhesion or welding. By joining these components together, a light deflector having a movable portion that is less deformed during high-speed driving is fabricated.

Alternatively, components constituting light deflectors, such as movable portions and torsion springs, may be separately made of silicon wafers using a micromachining process. This reduces waste portions of the wafers, leading to an increase in the number of components obtained from a single silicon wafer. Accordingly, it is possible to provide inexpensive light deflectors. Further, by making components, such as torsion springs, separately from movable portions made of a (110) substrate, the torsion springs may be made of any desired material. For example, the torsion springs may be weakened to lower the resonance frequency, or may be hardened to increase the resonance frequency. Accordingly, it is possible to provide light deflectors with a high resonance frequency and light deflectors with a low resonance frequency. In particular, it is possible to provide light deflectors having torsion springs made of silicon, whose crystal orientation is oriented in any desired orientation.

The torsion springs are made of a (110) substrate, such that the crystal orientation parallel to the torsional axis is the [111] orientation. The movable portion and the torsion springs may be joined together by adhesion or welding. This reduces variation in torsion spring constant due to manufacturing error of the width of the torsion springs or the like. Accordingly, the defect rate of torsion springs due to manufacturing error can be reduced, leading to a reduction in manufacturing cost.

Alternatively, the torsion springs may be made of a (111) substrate. This reduces variations in spring constants due to misalignment of the crystal orientation of the torsion springs with the intended orientation during fabrication. Accordingly, again, the defect rate of torsion springs due to manufacturing error can be reduced, leading to a reduction in manufacturing cost.

The present invention will now be described in more detail with specific examples.

### EXAMPLE 1

A configuration of a light deflector according to Example 1 will be described with reference to FIGS. 1A and 1B. As described above, FIG. 1A is a plan view of a light deflector of the present invention, and FIG. 1B is a sectional view of the light deflector shown in FIG. 1A, taken along line IB-IB. The light deflector of the present invention has a supporting portions 101, a movable portion 103 having a reflecting surface 102, and torsion springs 104a, 104b connecting the movable portion 103 to the supporting portions 101 in a manner allowing the movable portion 103 to torsionally oscillate about a torsional axis 108. The movable portion 103 is made of a (110) substrate, such that the crystal orientation parallel to the principal surface (the surface having the reflecting surface 102 in FIGS. 1A and 1B) of the movable portion 103 and perpendicular to the torsional axis 108 is the [111] orientation.

That is, a crystal orientation 1000 of the movable portion 103 shows that the principal surface of the movable portion 103 lies in the (110) crystal plane, and the crystal orientation parallel to the principal surface of the movable portion 103 and perpendicular to the torsional axis 108 is the [111] orientation.

The movable portion 103 has a length perpendicular to the torsional axis 108 of 3.0 mm, a length parallel to the torsional axis 108 of a 1.0 mm, and a thickness of 0.3 mm. Although the movable portion 103 is in the shape of a rectangular parallelepiped, it may be in the shape of an elliptic cylinder or the like. The reflecting surface 102 is made of aluminum, by vacuum deposition. The supporting portions 101, the movable portion 103, and the torsion springs 104a, 104b are made of a (110) substrate, using a photolithography process and a dry etching process used in a semiconductor manufacturing method. The crystal orientation of the movable portion 103 parallel to the principal surface of the movable portion 103 and perpendicular to the torsional axis 108 is the [111] orientation.

The movable portion 103 has a hard magnet 106 and is magnetized perpendicularly to the torsional axis 108 (in the left-right direction in FIG. 1B). The light deflector according to Example 1 has a resonance frequency of about 2000 Hz. When an AC current having a frequency equal to the resonance frequency is applied to a coil 107, a magnetic field is generated, and a torque is applied to the movable portion 103. Thus, the movable portion 103 torsionally oscillates by an optical angle of 100 degrees, while consuming less power.

In this configuration, the largest amount of deformation of the movable portion 103 is about 40 nm, which is smaller than the amount of deformation of a movable portion to which the present invention is not applied. Accordingly, deterioration in spot shape of the reflected light can be reduced.

### EXAMPLE 2

A configuration of a light deflector according to Example 2 will be described with reference to FIGS. 2A and 2B. FIG. 2A is a plan view of the light deflector of the present invention, and FIG. 2B is a sectional view of the light deflector shown in FIG. 2A, taken along line IIB-IIB. The light deflector according to Example 2 has substantially the same configuration as the light deflector according to Example 1. In Example 2, torsion springs 204a, 204b are made of a (110) substrate. A crystal orientation 2001 of the torsion springs 204a, 204b parallel to the torsional axis 208 is the [111] orientation. Torsion springs oriented in the [111] orientation can be made of a (110) substrate. The cross section of the torsion springs, i.e., a section perpendicular to the torsional axis 208, is rectangular.

The movable portion 203 is made of a (110) substrate, using a photolithography process and a dry etching process used in a semiconductor manufacturing method. The movable portion 203 and the torsion springs 204a and 204b are bonded together, as shown in FIG. 2B. They are bonded together such that the crystal orientation parallel to the principal surface of the movable portion 203 and perpendicular to the torsional axis 208 is the [111] orientation.

By separately making the components, such as movable portions and torsion springs, of silicon wafers, waste portions of the wafers can be reduced, leading to an increase in the number of components obtained from a single silicon wafer, and a reduction in manufacturing cost.

As shown in FIG. 7, torsion springs made of a (110) substrate whose crystal orientation parallel to the torsional axis 208 is the [111] orientation have the smallest torsion spring constant.

This configuration reduces variations in torsion spring constants even if the torsion springs 204a, 204b have a manufacturing error of about 1 μm with respect to the width thereof, reducing a variation in resonance frequency due to manufacturing error. The amount of deformation of the movable portion during high-speed driving can be reduced by orienting the crystal orientation of the movable portion as above.

### EXAMPLE 3

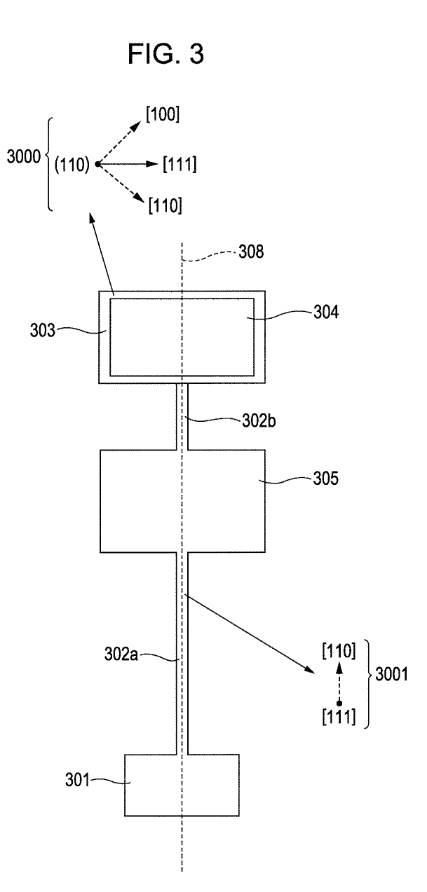

A configuration of a light deflector according to Example 3 will be described with reference to FIG. 3. The light deflector according to Example 3 has two movable portions 303 and 305. The movable portion 303 has a reflecting surface 304. The movable portions 303 and 305 are supported by a plurality of torsion springs 302a, 302b connecting the movable portions 303 and 305 to a supporting portion 301 in a manner allowing the movable portions 303 and 305 to torsionally oscillate about a single torsional axis.

The movable portion 303 has a length perpendicular to the torsional axis 308 of 3.0 mm, a length parallel to the torsional axis 308 of 1.0 mm, and a thickness of 0.3 mm. The movable portion 305 has a length perpendicular to the torsional axis 308 of 3.0 mm, a length parallel to the torsional axis 308 of 1.0 mm, and a thickness of 0.3 mm. The movable portion 305 has a permanent magnet (not shown) and can be driven by an electromagnetic force, similarly to Example 1.

The torsion springs 302a, 302b are made of a (111) substrate. As shown in FIG. 7, the spring constants of torsion springs made of a (111) substrate are substantially uniform over the entire range of angles with respect to the [110] orientation. Accordingly, even if the crystal orientation of torsion springs parallel to the torsional axis is misaligned with the intended orientation during fabrication, the torsion spring constants of the torsion springs are substantially uniform. Thus, a variation in resonance frequency due to manufacturing error can be reduced.

The light deflector according to Example 3 torsionally oscillates about the torsional axis 308 at a frequency of f1, which serves as the reference frequency and is referred to as a primary natural oscillation mode, and at a frequency of f2, which is double the reference frequency and is referred to as a secondary natural oscillation mode. By torsionally oscillating the light deflector at the primary and secondary torsional oscillation modes simultaneously, the displacement angle of the light reflected by the reflecting surface 304 provided on the movable portion 303 during deflection and scanning is controlled by these two oscillation modes. Because the light deflector according to Example 3 has the primary torsional oscillation mode, which serves as the reference frequency, and the secondary torsional oscillation mode, which is double the reference frequency, the light deflector can be oscillated with a sawtooth waveform. This allows the light deflector to perform optical scanning with little variation in angular speed, further making the spot shape of the reflected light uniform.

### EXAMPLE 4

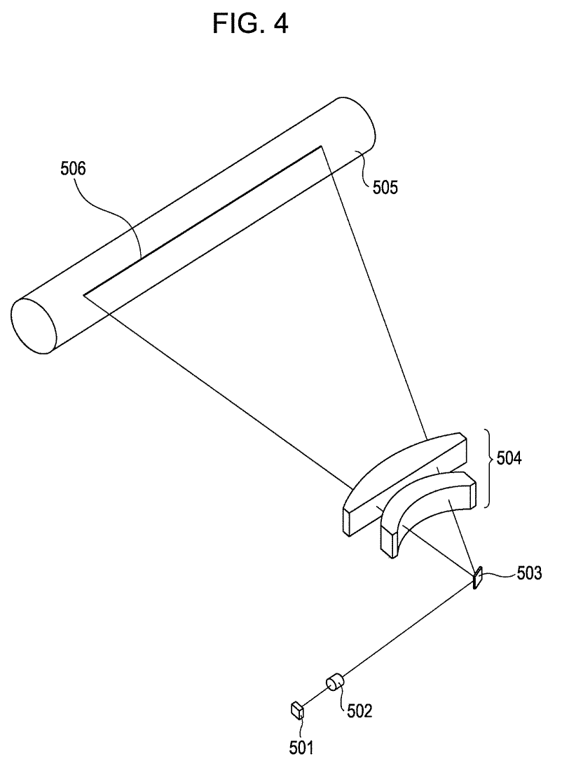

FIG. 4 is a schematic diagram of an optical apparatus according to Example 4 using the above-described light deflector. FIG. 4 is a schematic diagram of an image forming apparatus, which is an exemplary optical apparatus. FIG. 4 shows a light deflector 503 of the present invention, which deflects incident light and performs one-dimensional scanning. FIG. 4 also shows a laser source 501, a lens or a lens group 502, a writing lens or a writing lens group 504, a photosensitive body 505, and a scanning locus 506. A laser beam emitted from the laser source 501 is modulated according to the timing of deflection and scanning of light, and is caused to one-dimensionally scan the photosensitive body 505 by the light deflector 503. The scanning of the laser beam forms an image on the photosensitive body 505 through the writing lens 504. The photosensitive body 505 is uniformly charged by a charger (not shown). By scanning the photosensitive body 505 with the laser beam, an electrostatic latent image is formed thereon. A developing unit (not shown) forms a toner image on the electrostatic latent image. This toner image is transferred and fixed onto a sheet (not shown), for example, whereby an image is formed on the sheet. The use of a light deflector that maintains the flatness of the reflecting surface and has less fluctuation in frequency due to manufacturing error enables a stable image to be formed.

When a light deflector of the present invention is applied to an image display apparatus such as a projection display, the image display apparatus should be configured as follows. A light source emits a light beam modulated according to image data. The light deflector of the present invention deflects the light beam and irradiates an object with the light beam to form an image thereon. The light deflector is configured to deflect the light beam in the main and sub scanning directions of the object.

As described above, the light deflector of the present invention can be applied to the above-described optical apparatuses.

The present invention relates to oscillating devices, light deflectors, and image forming apparatuses using the light deflectors. Light deflectors are suitably used in, for example, projection displays that project images by deflecting light and performing scanning, image forming apparatuses using an electrophotography process, such as laser beam printers and digital copying machines.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-197393, filed Jul. 30, 2007, which is hereby incorporated by reference herein in its entirety.

What is claimed is:

1. An oscillating device comprising:
a supporting portion;
a movable portion;
a torsion spring connecting the movable portion to the supporting portion in a manner allowing the movable portion to torsionally oscillate about a torsional axis; and
a driving unit configured to oscillate the movable portion,
wherein the movable portion is made of single-crystal silicon;
wherein a principal surface of the movable portion lies in a (110) crystal plane; and
wherein a crystal orientation parallel to the principal surface of the movable portion and perpendicular to the torsional axis is a [111] orientation.

2. The oscillating device according to claim 1,
wherein the torsion spring is made of single-crystal silicon, and
wherein the crystal orientation of the torsion spring parallel to the torsional axis is the [111] orientation.

3. The oscillating device according to claim 1,
wherein the torsion spring is made of single-crystal silicon whose principal surface lies in a (111) crystal plane.

4. The oscillating device according to claim 1,
wherein the supporting portion, the movable portion, and the torsion spring are integrally made of single-crystal silicon.

5. A light deflector comprising the oscillating device according to claim 1, the oscillating device further having a reflecting surface provided on the movable portion.

6. The light deflector according to claim 5, comprising:
a plurality of movable portions; and
a plurality of torsion springs configured to support the plurality of movable portions in a manner allowing the movable portions to torsionally oscillate about a single torsional axis,
wherein at least one of the plurality of movable portions has the reflecting surface, and
wherein the plurality of movable portions oscillate about the torsional axis at a natural frequency serving as a reference frequency and at a natural frequency that is an integral multiple of the reference frequency.

7. An image forming apparatus comprising:
a light source;
the light deflector according to claim 5; and
a photosensitive body,
wherein the light deflector deflects light emitted from the light source and irradiates the photosensitive body with a part of the light to form an electrostatic latent image.
